(19) United States
(12) Patent Application Publication
(10) Pub. No.: US 2024/0161660 A1
(43) Pub. Date: May 16, 2024

(54) DISPLAY DEVICE

(71) Applicant: LITE-ON TECHNOLOGY CORPORATION, TAIPEI CITY (TW)

(72) Inventors: CHENG-YAN HSIEH, Taipei City (TW); SHIH-YUAN KUO, NEW TAIPEI CITY (TW); Jie-Ting Tsai, New Taipei City (TW)

(21) Appl. No.: 18/509,431

(22) Filed: Nov. 15, 2023

Related U.S. Application Data
(60) Provisional application No. 63/425,732, filed on Nov. 16, 2022.

(30) Foreign Application Priority Data
Oct. 20, 2023 (CN) 202322816576.2

(51) Int. Cl. G09F 9/302; G09F 13/14

(52) U.S. Cl. CPC G09F 9/3023; G09F 13/14; G09F 2013/142

(57) ABSTRACT

A display device and a housing of the display device are provided. The housing of the display device includes a reflective cover. The reflective cover has a plurality of segments formed on a front side of the reflective cover and a plurality of segment structures correspondingly formed on a rear side of the reflective cover. At least one of the segment structures has a notch formed thereat. Positions of the notches of the at least two adjacent ones of the segment structures are not opposite to each other.

### CROSS-REFERENCE TO RELATED PATENT APPLICATION

This application claims the benefit of priority to China Patent Application No. 202322816576.2, filed on Oct. 20, 2023, in the People's Republic of China. The entire content of the above identified application is incorporated herein by reference.

This application claims the benefit of priority to the U.S. Provisional Patent Application Ser. No. 63/425,732, filed on Nov. 16, 2022, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a display device, and more particularly to a plastic injection-molded display device for characters.

### BACKGROUND OF THE DISCLOSURE

In the existing technology, display devices are widely used in daily life. The existing display device is manufactured by processes of injection molding the frame, applying an optical film layer on the frame, dispensing and leveling glue, and baking the display device.

However, because the injection molding runner is designed to be serially connected in-between character segments, when a light-emitting unit emits light, light leakage or interference may occur between the character segments.

### SUMMARY OF THE DISCLOSURE

In response to the above-referenced technical inadequacies, the present disclosure provides a display device, so as to prevent light leakage or light interference from occurring between segments of the display device by improving a structural design of the display device.

In order to solve the above-mentioned problems, one of the technical aspects adopted by the present disclosure is to provide a display device. The display device includes a reflective cover. A plurality of segments formed on a front side of the reflective cover and a plurality of segment structures correspondingly formed on a rear side of the reflective cover. Each of the segment structures has a notch formed thereat, at least two adjacent ones of the segment structures have an inner channel formed therebetween, and positions of the notches of the at least two adjacent ones of the segment structures are not opposite to each other.

In one of the possible or preferred embodiments, two or more of the plurality of segment structures of the display device are in fluid communication.

In one of the possible or preferred embodiments, the reflective cover includes a frame and a plurality of partitions, and the plurality of partitions are disposed between at least two adjacent ones of the light-emitting units. The frame, the partitions, and the light-emitting units have a relation of X−Y<Z, where X is a thickness of the frame, Y is a thickness of the partitions, and Z is a height of the light-emitting units.

Therefore, in the display device and the light-emitting device provided by the present disclosure, by virtue of “the at least two adjacent ones of the segment structures having an inner channel formed therebetween, and positions of the notches of the at least two adjacent ones of the segment structures being not opposite to each other,” a transmission path of light can be extended, such that light-emitting effects can be uniform among the segments.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1A is a schematic view of a front side of a reflective cover of a display device according to one embodiment of the present disclosure;

FIG. 1B is a schematic view of a rear side of the reflective cover of FIG. 1A according to one embodiment of the present disclosure;

FIG. 2A is a schematic view of a rear side of a housing of a display device according to one embodiment of the present disclosure;

FIG. 2B is a schematic cross-sectional view of the embodiment of FIG. 2A;

FIG. 2C is another schematic cross-sectional view of the embodiment of FIG. 2A;

FIG. 2D is a schematic exploded view of the embodiment of FIG. 2A;

FIG. 3A is a schematic view of a front side of a display device according to one embodiment of the present disclosure;

FIG. 3B is a schematic view of a rear side of the embodiment of FIG. 3A;

FIG. 4A is a schematic cross-sectional view of a display device according to one embodiment of the present disclosure;

FIG. 4B is a schematic cross-sectional view of a display device according to one embodiment of the present disclosure;

FIG. 4C is a schematic cross-sectional view of a display device according to one embodiment of the present disclosure; and

FIG. 5 is a schematic view of a light-emitting device according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Embodiments

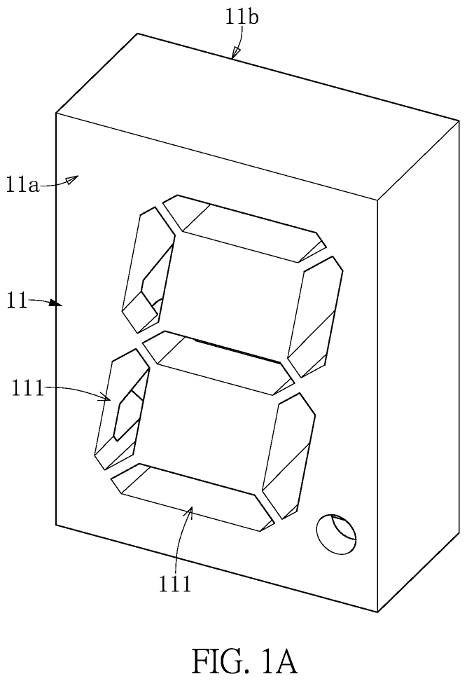

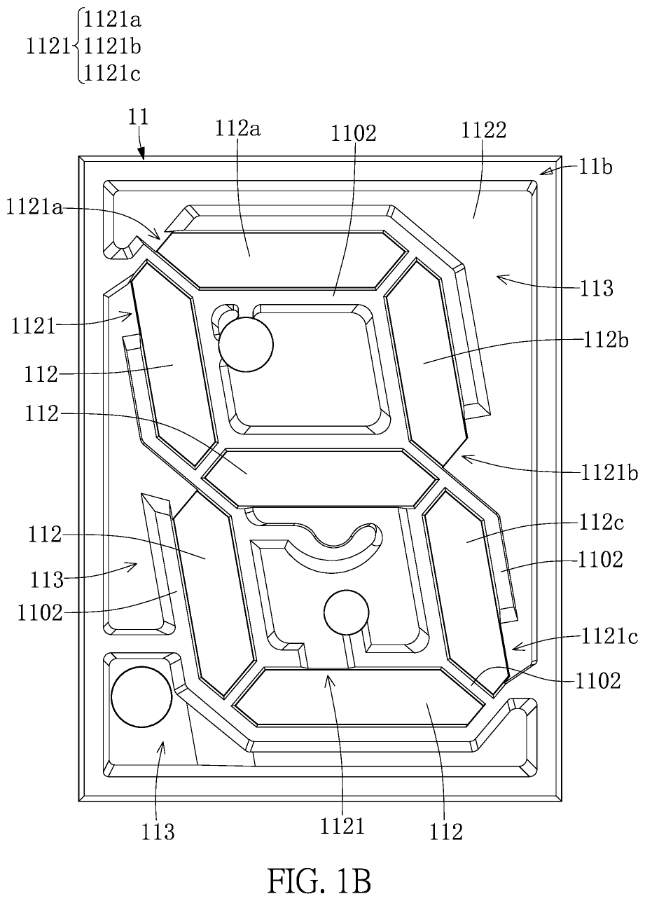

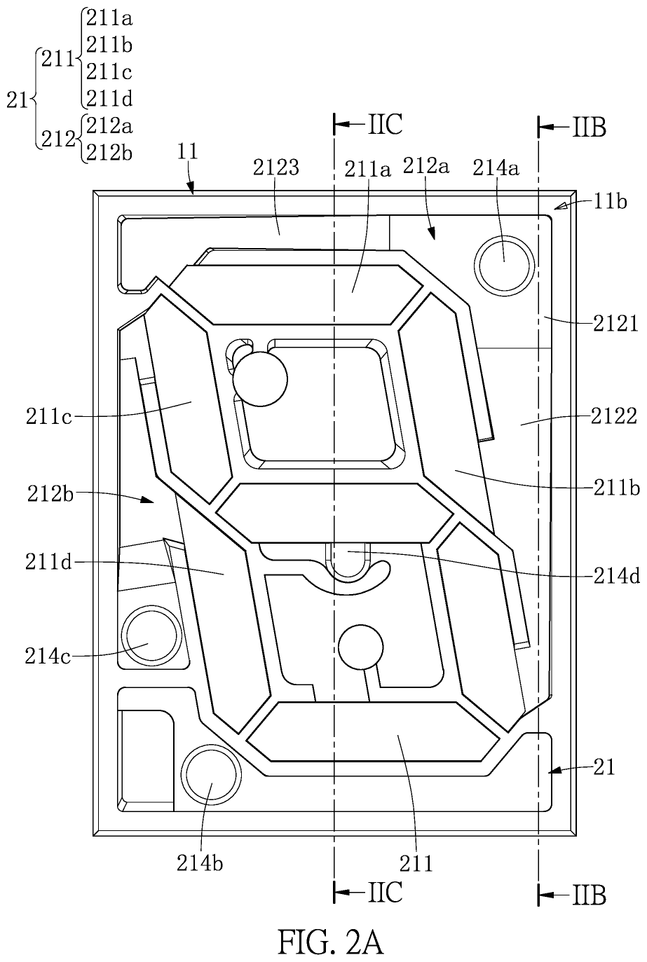

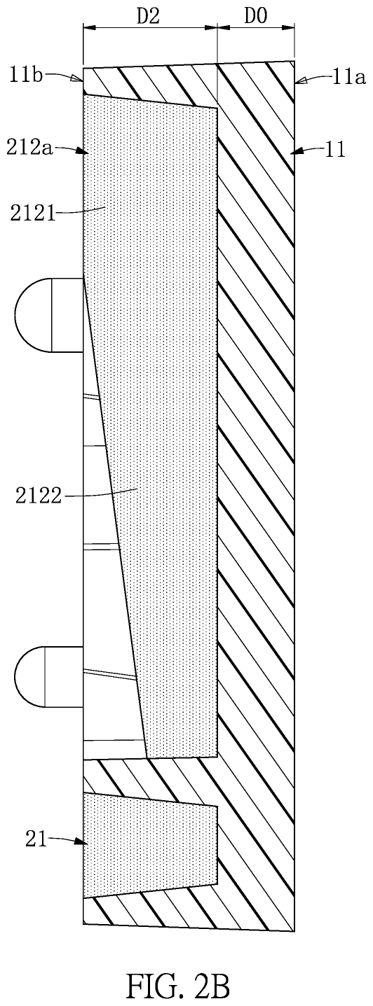

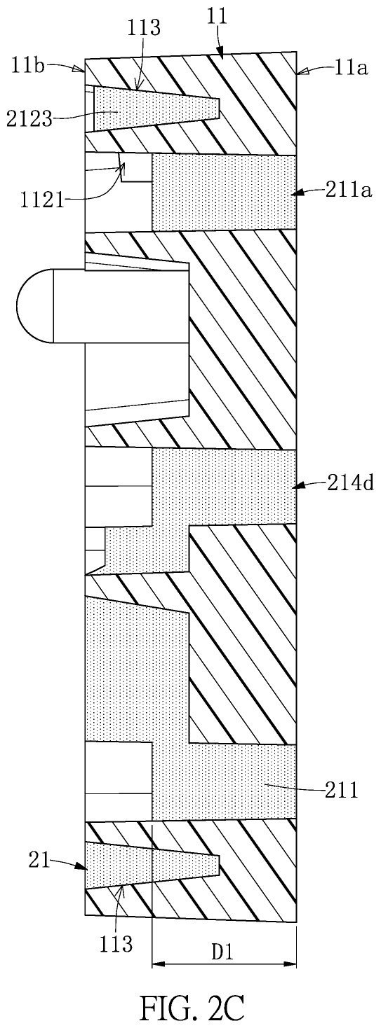

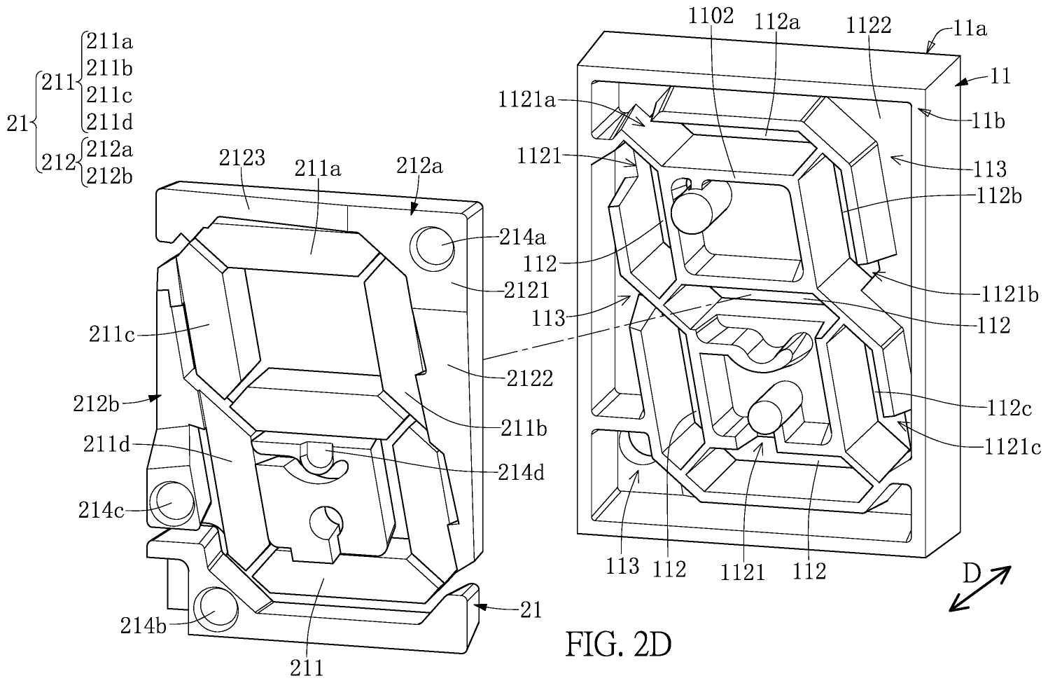

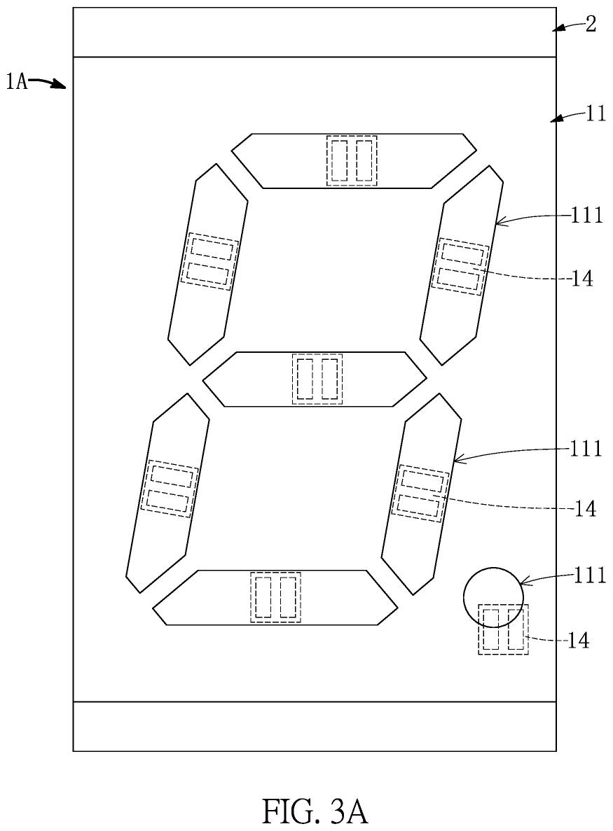

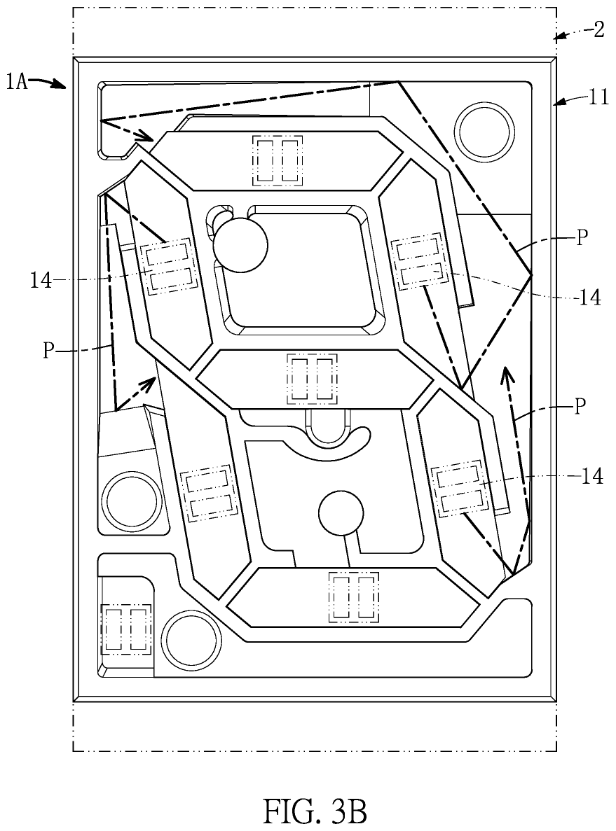

Referring to FIG. 1A and FIG. 1B, FIG. 1A is a schematic view of a front side 11a of a reflective cover 11 of a display device 1 according to one embodiment of the present disclosure, and FIG. 1B is a schematic view of a rear side 11b of the reflective cover 11 of FIG. 1A according to one embodiment of the present disclosure. As shown in FIG. 1A, a plurality of segments 111 are formed on the front side 11a of the reflective cover 11, and a plurality of segment structures 112 are correspondingly formed on the rear side 11b of the reflective cover 11 (as shown in FIG. 1B). As shown in FIG. 1B, at least one segment structure 112 is defined by a plurality of partitions 1102. There is a notch 1121 formed on one of the plurality of partitions 1102 which surrounding one segment structure 112. At least two adjacent ones of the segment structures 112 may have an inner channel 113 formed therebetween, and a bottom surface of the inner channel 113 is an inner bottom 1122 of the reflective cover 11. It should be noted that, positions of the notches 1121 of the at least two adjacent ones of the segment structures 112 connected by the inner channel 113 are not opposite to each other. The positions of the notches 1121 being “not opposite to each other” indicates that the positions of the notches 1121 are not adjacent to each other or do not face toward each other. According to embodiments as shown in FIG. 1A and FIG. 1B, the aforementioned segments 111 are arranged to substantially form digit, text, symbol and graph and decimal point (DP), especially on a shape of a figure “8”, but the present disclosure is not limited thereto. According to certain embodiments, the plurality of segments 111 can also form shapes of other texts, numbers (digits), symbols, graphs or decimal point (DP). In the embodiment as shown in FIG. 1B, two or more of the segment structures are in fluid communication. For example, a notch 1121a of a segment structure 112a and a notch 1121b of a segment structure 112b are connected through one L-shaped section of the inner channel 113, and the notch 1121b of the segment structure 112b and a notch 1121c of a segment structure 112c are connected through another L-shaped section of the inner channel 113. That is, the plurality of notches 1121a, 1121b, and 1121c of the plurality of segment structures 112 on the same inner channel 113 are not adjacent to one another. In other words, a distance between the notches 1121a, 1121b, and 1121c is at least half a length of the segment (½×L, in which L is the length of the segment). Moreover, the longest distance between two segments is twice the length of the segments (2L), so that the issue of light leakage can be reduced. According to the embodiment as shown in FIG. 1B, on the rear side 11b of the reflective cover 11, the plurality of segment structures 112 and the plurality of partitions 1102 surround and define two concave regions that are substantially located in the center of the reflective cover 11. A bottom surface of the concave regions is also the inner bottom 1122 of the reflective cover 11. One of the concave regions is a closed concave slot that can reduce a weight of the reflective cover 11, and another one of the concave regions is a section of the inner channel 113 that is substantially Z-shaped (in other words, a shape formed by an upper L-shaped portion and a lower L-shaped portion) to connect two of the plurality of segment structures 112. The notch 1121 is formed at each of the segment structures 112. The notches 1121 of the two of the plurality of segment structures 112 are separate from each other by the partitions 1102. That is, positions of the notches 1121 are not opposite to each other. A placement of a gate (such as injection molding gate) between the at least two adjacent ones of the segment structures 112 is used for filling transparent material to form a housing of the display device. The transparent material flows within the inner channel 113 and then fills the adjacent segments 111 via the corresponding notch 1121. Each of the notches 1121 of the at least two adjacent ones of the segment structures 112 is located at a position away from the gate placement. Referring to FIG. 2A to 2D, FIG. 2A is a schematic view of a rear side of a housing of a display device according to one embodiment of the present disclosure, FIG. 2B is a schematic cross-sectional view of the embodiment of FIG. 2A, FIG. 2C is another schematic cross-sectional view of the embodiment of FIG. 2A, and FIG. 2D is a schematic exploded view of the embodiment of FIG. 2A. In the embodiments as shown in FIG. 2A to 2D, a light-emitting unit 14 and a circuit substrate 2 are omitted (the light-emitting unit 14 and the circuit substrate 2 are provided in FIGS. 3A and 3B). The display device 1 further includes a light-permeable body 21, and the light-permeable body 21 is formed by a process of respectively filling materials for injection molding into the inner channel 113 through gates 214a to 214d. The light-permeable body 21 includes a plurality of light-permeable portions 211, and the plurality of segments 111 correspond to the plurality of light-permeable portions 211, respectively. A surface of the light-permeable portions 211 are preferably flush with or lower than the front side 11a of the reflective cover 11, but the present disclosure is not limited thereto. The light-permeable body 21 further includes a communication portion 212 that connects at least two adjacent ones of the light-permeable portions 211 in the inner channel 113. As shown in FIG. 2A and FIG. 2B, a communication portion 212a connects three adjacent ones of the light-permeable portions 211a to 211c, and a communication portion 212b connects two adjacent ones of the light-permeable portions 211d and 211e. In this embodiment, a thickness of the communication portions 212a and 212b is different from a thickness of the light-permeable portions 211a to 211e. For example, the communication portion 212a includes a connecting section 2121, a ramp section 2122, and a step section 2123. The connecting section 2121 has the greatest thickness among the three sections in a direction D, the ramp section 2122 has the second greatest thickness, and the step section 2123 has the smallest thickness. In addition, inclinations of the ramp section 2122 and the step section 2123 are substantially between 5 degrees and 10 degrees, and the inclinations of the ramp section 2122 and the step section 2123 are preferably equal to or approximate to each other. For example, the inclination of the ramp section 2122 is 6.5 degrees, and the inclination of the step section 2123 is 7 degrees, so that a difference of the two inclinations is within 1 degree. The design of inclination and thickness in the aforementioned structure can reduce a light leakage when light is transmitted from the light-permeable portion via the communication portion 212, but the present disclosure is not limited thereto. The communication portion 212 can be formed by a plurality of step sections or a plurality of slope sections, or formed by the plurality of step sections and the plurality of slope sections being connected to each other. Therefore, a thickness D2 of the communication portion 212 in the direction D (as shown in FIG. 2B with the communication portion 212a as an example) is different from a thickness D1 of the light-permeable portion 211.

In addition, the thickness D1 of the light-permeable portion 211 in the direction D is at least 1.2 times (preferably 1.3 times to 1.4 times) a thickness D0 of the inner bottom 1122 of the reflective cover 11. In certain embodiments, the light-permeable portion 211 is connected with the communication portion 212 at a junction having an overlapping thickness in the direction D (i.e., a thickness direction), and the overlapping thickness is greater than 15% and less than 35% of the thickness D1 of the light-permeable portion 211. Preferably, the overlapping thickness is between 25% and 30% of the thickness D1. On the other hand, the overlapping thickness is greater than 30% and less than 50% of the thickness D2 of the communication portion 212, and the overlapping thickness is preferably between 35% and 40% of the thickness D2. In addition, the overlapping thickness is preferably between 15% and 25% of an overall thickness of the display device 1. The aforementioned structural design improves a bonding strength of the light-permeable portion and the reflective cover, and effectively limits the cost and weight of the display device 1.

Furthermore, as shown in FIG. 2D, the light-permeable body 21 includes the plurality of light-permeable portions 211 that respectively correspond to the segments 111 and the plurality of communication portions 212 that connect the plurality of light-permeable portions 211. One of the light-permeable portions 211 is spaced from an adjacent one of the communication portions 212 by a gap, and the light-permeable portion 211 and the communication portion 212 are only connected to each other by a connection protrusion, as described below. For example, multiple gaps are formed between the three adjacent ones of the light-permeable portions 211a to 211c and the communication portion 212a. The light-permeable portion 211a is only connected to the step section 2123 at a position of a connection protrusion 2123a, and the remaining positions between the light-permeable portion 211a and the step section 2123 are spaced apart by a gap such that the light-permeable portion 211a and the step section 2123 are not in contact with each other at the remaining positions. The light-permeable portions 211a and 211b are spaced apart from the connecting section 2121 by a gap at a position at which the light-permeable portions 211a and 211b is adjacent to the connecting section 2121, such that the light-permeable portions 211a and 211b are not in contact with the connecting section 2121. The light-permeable portions 211b and 211c are connected to the slope section 2122 at a position of connection protrusions 2122a and 2122b, and the remaining positions between the light-permeable portions 211b and 211c and the slope section 2122 are respectively spaced apart by two gaps such that the light-permeable portions 211b and 211c and the slope section 2122 are not in contact with each other at the remaining positions. The connection protrusions 2122a, 2122b, and 2123a of any two adjacent ones of the light-permeable portions 211 are not adjacent to each other in position. Moreover, a distance between any two adjacent ones of the connection protrusions is preferably 0.5 to 2 times a length of one of the light-permeable portions 211, so as to reduce light leakage when light is transmitted from a connection protrusion to the adjacent light-permeable portion.

Referring to FIG. 3A and FIG. 3B, FIG. 3A is a schematic view of a front side of a display device 1A according to one embodiment of the present disclosure, and FIG. 3B is a schematic view of a rear side of the embodiment of FIG. 3A. In this embodiment, the display device 1A further includes a plurality of light-emitting units 14 respectively disposed in the plurality of segments 111. The light-emitting units 14 are located on the circuit substrate 2, and a light beam emitted by each of the light-emitting units 14 is emitted corresponding to a shape of the segments toward the front side 11a. However, part of the light may be leaked through notches 1211 of the segment structures 112. In this case, the leaked light can be shielded in a predesigned light transmission path (i.e., the communication portion 212) so as to prevent an optical crosstalk between the segments. Furthermore, as shown in FIG. 3B, in this embodiment, in addition to light beams emitted from light-emitting units 14 passing through the light-permeable portions 211 to be projected in a forward direction and corresponding to a shape of the segments, part of light beams P overflow outward from the notches 1211 of the segment structures 112. In the communication portions 212 of the light-permeable body 21, the light beams P undergo two reflections, so that part of the light energy can be consumed. By a suitable arrangement of notch positions, such as extending the light transmission path by at least a length of half a segment or two segments, the light energy is effectively eliminated and an impact of the light energy on adjacent segments is reduced. In addition, the light-permeable body 211 and the communication portion 212 are not completely overlapped with each other, so that the light transmission path can be interrupted and the amount of light overflow is reduced. Furthermore, according to certain embodiments, the light transmission path of the light beam emitted by the light-emitting unit 14 is greater than 1 mm. The light-emitting unit 14 can be an LED, and according to certain embodiments, the light-emitting unit 14 can also be a μLED (micro LED), but the present disclosure is not limited thereto. In addition, light beams emitted by multiple light-emitting units 14 (e.g., RGB sub-pixels) may be the same or different.

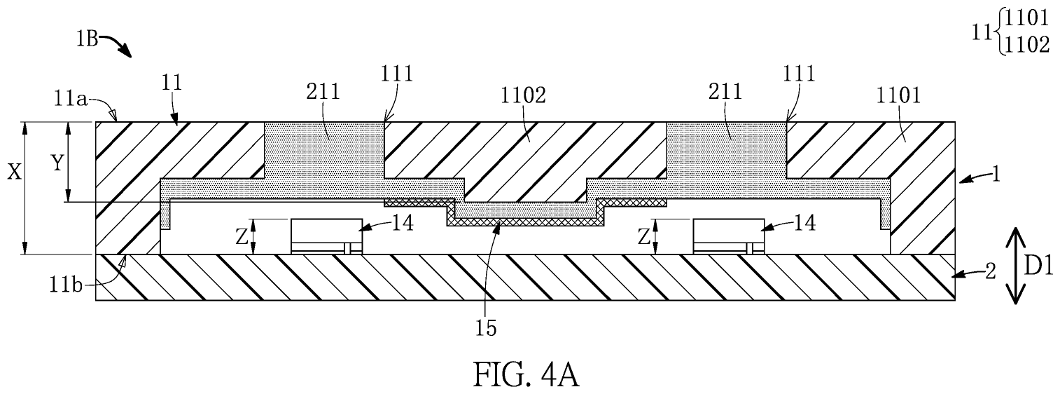

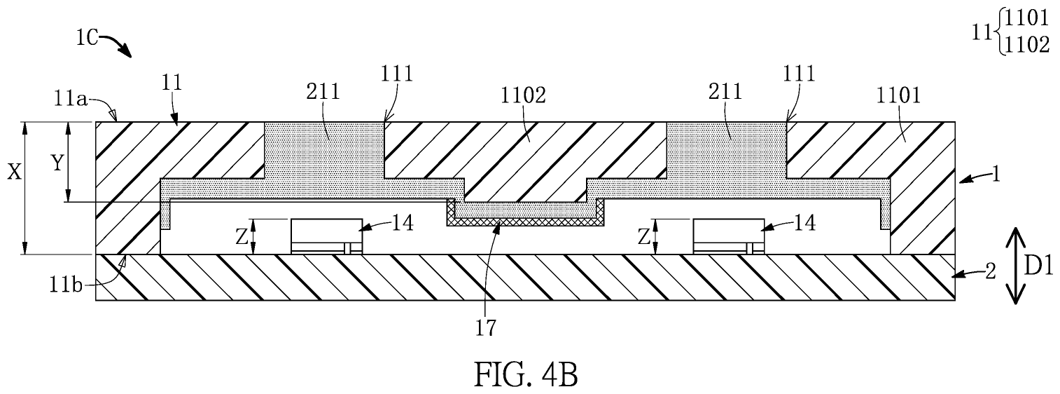

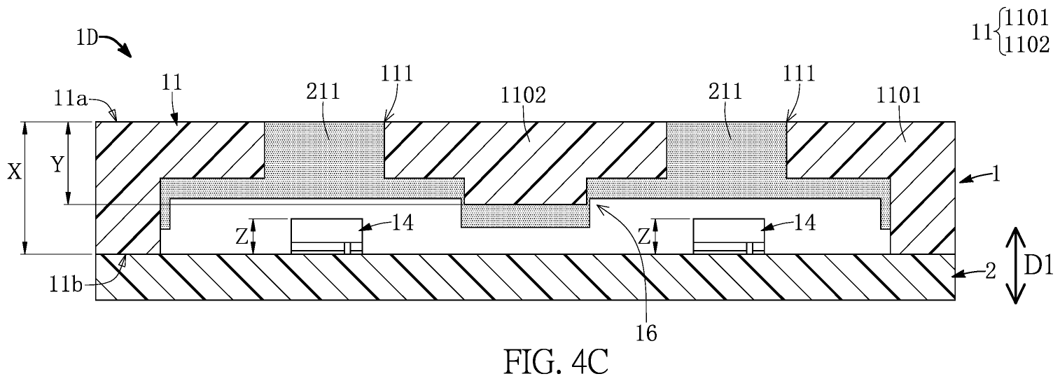

Referring to FIG. 4A to 4C, FIG. 4A to 4C are schematic cross-sectional views of display devices 1B, 1C, and 1D according to one embodiment of the present disclosure. The reflective cover 11 includes a frame 1101 and a plurality of partitions 1102′, and the plurality of partitions 1102′ are positioned between at least two adjacent ones of the light-emitting units 14. The frame 1101, the partitions 1102′, and the light-emitting units 14 have a relation of X−Y<Z, in which X is a thickness of the frame 1101, Y is a thickness of the partitions 1102′, and Z is a height of the light-emitting units 14. In this structure, the thickness of the partitions 1102′ is smaller than the thickness of the frame 1101, so that an overall weight of the display device can be reduced. In these embodiments, a surface of the partitions 1102′ is a rough surface, or the surface of the partitions 1102′ undergoes a roughening process. For example, carbon black 15 (as shown in FIG. 4A) or a light-absorbing film 17 (as shown in FIG. 4B) is disposed on the surface of the partitions 1102′. Furthermore, one of the partitions 1102′ can be covered by an extension (i.e., an extension portion) of the light-permeable portion 211 for improving a structural strength, and a surface treatment structure, carbon black, and a light-absorbing film can be formed on the surface of the light-permeable portion 211. In certain embodiments, step structures 16 can be formed on lateral sides of the surface of the light-permeable portion 211 on the partition 1102′ (as shown in FIG. 4C). According to the aforementioned embodiments, an issue of light leakage between the segments when a thickness of the partitions 1102′ is smaller can be minimized.

According to certain embodiments, the aforementioned reflective cover 11 may be made of nylon, polypropylene (PP), polyethylene terephthalate (PET), or polymethyl methacrylate (PMMA), and the present disclosure is not limited thereto. According to some embodiments, the reflective cover 11 has a reflectivity of greater than or equal to 90%.

According to certain embodiments, the aforementioned light-permeable body 21 can be thermoplastic, such as PPA (polyphthalamide) or thermosetting material, such as polysiloxane, epoxy resin, or liquid silicone rubber, but the present disclosure is not limited thereto. According to certain embodiments, the light transmittance of the light-permeable body 21 is greater than or equal to 80%.

According to one embodiment of the present disclosure, a distance between the notches 1211 of the at least two adjacent ones of the segment structures 112 is 0.5 to 2 times a length of the segment 111.

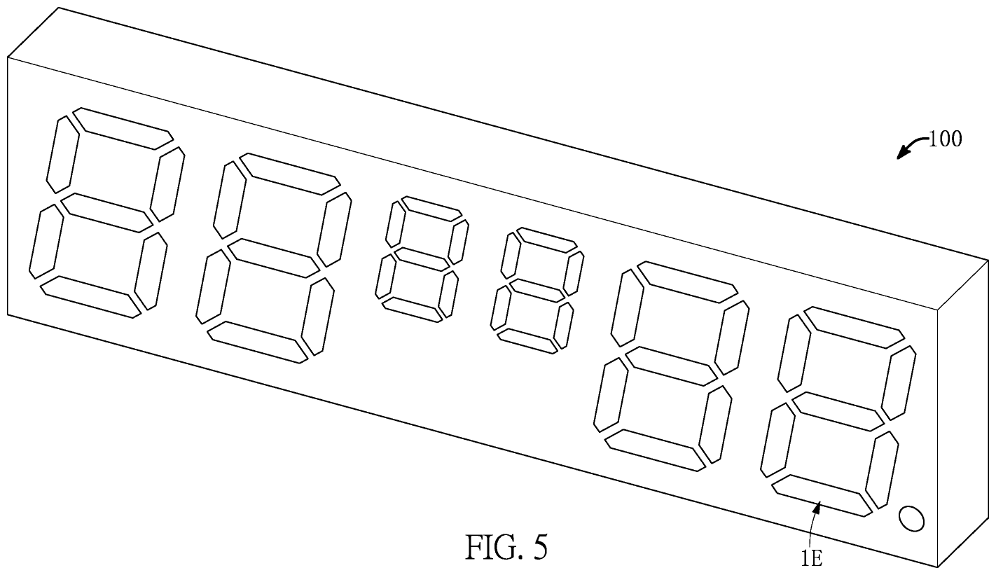

Referring to FIG. 5, FIG. 5 is a schematic view of a light-emitting device 100 according to one embodiment of the present disclosure. The light-emitting device 100 includes a circuit substrate (not shown in the figures) and a display device 1E disposed on the circuit substrate. According to certain embodiments, the light-emitting device may be a display panel. The aforementioned light-emitting device may also be a household appliance, such as a washing machine, a television set, or a microwave oven. According to certain embodiments, the display device may also be applied to industrial machinery. For example, the light-emitting device may be an industrial controller. According to certain embodiments, the display device may also be adopted in the entertainment industry. For example, the light-emitting device can be a gaming machine. However, the above description only represents certain embodiments of the present disclosure, and the present disclosure is not limited thereto.

### Beneficial Effects of the Embodiments

Therefore, in the display device and the light-emitting device provided by the present disclosure, by virtue of “the segment structures having an inner channel formed therebetween, and positions of the notches of the at least two adjacent ones of the segment structures being not opposite to each other,” a transmission path of light can be extended, such that light-emitting effects can be uniform among the segments.

In addition, according to certain embodiments, by virtue of “the reflective cover including a frame and a plurality of partitions, and the plurality of partitions being disposed between at least two adjacent ones of the light-emitting units; the frame, the partitions, and the light-emitting units having a relation of X−Y<Z, with X being a thickness of the frame, Y being a thickness of the partitions, and Z being a height of the light-emitting units,” issues of light leakage or light interference between the segments can be effectively addressed.

Furthermore, according to certain embodiments, by virtue of “at least one of the light-permeable portions having a rough surface,” or “carbon black or a light-absorbing film being provided on a surface of at least one of the light-permeable portions,” issues of light leakage or light interference between the segments can also be improved.

Moreover, according to certain embodiments, the reflective cover and the light-permeable body are formed in two individual processes. That is, the reflective cover and the light-permeable body are respectively disposed in two processes. By the aforementioned technical solutions, the display device or the light-emitting device that adopts the display device has high processing efficiency and good product reliability.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching. The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A housing of a display device, comprising:
a reflective cover having a plurality of segments formed on a front side of the reflective cover and a plurality of segment structures correspondingly formed on a rear side of the reflective cover;
wherein a notch is formed at each of the segment structures, and an inner channel is formed between at least two adjacent ones of the segment structures and wherein positions of the notches of the at least two adjacent ones of the segment structures are not opposite to each other.

2. The housing according to claim 1, wherein a distance between the notches of the at least two adjacent ones of the segment structures is 0.5 to 2 times a length of the segment.

3. The housing according to claim 1, further comprising a light-permeable body, wherein the light-permeable body includes a plurality of light-permeable portions, and the plurality of segments correspond to the plurality of light-permeable portions, respectively; wherein the light-permeable body further includes a communication portion that connects at least two adjacent ones of the light-permeable portions in the inner channel; wherein a thickness of the at least two adjacent ones of the light-permeable portions is different from a thickness of the communication portion.

4. The housing according to claim 3, wherein a surface of the light-permeable portions is flush with the or lower than front side of the reflective cover.

5. The housing according to claim 3, wherein the communication portion is formed by a plurality of step sections, by a plurality of slope sections, or by a combination of the plurality of step sections and the plurality of slope sections being connected to each other.

6. The housing according to claim 3, wherein the plurality of light-permeable portions are connected with the communication portion at a junction having an overlapping thickness in a thickness direction, and the overlapping thickness is greater than 15% and less than 35% of a thickness of the plurality of light-permeable portions.

7. The housing according to claim 1, wherein a placement of a gate is between the at least two adjacent ones of the segment structures on the rear side of the reflective cover, and each of the notches of the at least two adjacent ones of the segment structures is located at a position away from the predetermined position of the gate.

8. The housing according to claim 1, wherein the reflective cover includes a frame and a plurality of partitions, and the plurality of segment structures are defined by adjacent ones of the plurality of partitions.

9. A display device, comprising:
a circuit substrate;
a reflective cover disposed on the circuit substrate and having a plurality of segments formed on a front side of the reflective cover and a plurality of segment structures correspondingly formed on a rear side of the reflective cover;
a plurality of light-emitting units respectively disposed in the segment structures and electrically connected to the circuit substrate,
wherein a notch is formed at each of the segment structures, and positions of the notches of at least two adjacent ones of the segment structures are not opposite to each other.

10. The display device according to claim 9, wherein the reflective cover includes a frame and a plurality of partitions, and the plurality of partitions are disposed between at least two adjacent ones of the light-emitting units; wherein the frame, the partitions, and the light-emitting units have a relation of X−Y<Z, where X is a thickness of the frame, Y is a thickness of the partitions, and Z is a height of the light-emitting units.

11. The display device according to claim 10, wherein at least one of the plurality of partitions disposed between the at least two adjacent ones of the light-emitting units has a rough surface or has carbon black or a light-absorbing film provided thereon.

12. The display device according to claim 10, further comprising a light-permeable body, wherein at least one of the plurality of partitions disposed between the at least two adjacent ones of the light-emitting units includes an extension portion of the light-permeable body, and the extension portion of the light-permeable body on the plurality of partitions has a rough surface or has carbon black or a light-absorbing film provided thereon.

13. The display device according to claim 9, wherein a distance between the notches of the at least two adjacent ones of the segment structures is 0.5 to 2 times a length of the segment.

14. A display device, comprising:
a circuit substrate;
a plurality of light-emitting units disposed on the circuit substrate;
a reflective cover having a plurality of segments formed on a front side of the reflective cover and arranged to substantially form a shape of a FIG. 8, and a plurality of segment structures correspondingly formed on a rear side of the reflective cover; wherein each of the segment structures has a notch formed thereat, and wherein positions of the notches of at least two adjacent ones of the segment structures are not opposite to each other; and
a light-permeable body including a plurality of light-permeable portions; wherein the plurality of segments correspond to the plurality of light-permeable portions, respectively.

15. The display device according to claim 14, wherein at least two adjacent ones of the segment structures have an inner channel formed therebetween, and the light-permeable body further includes a communication portion that connects at least two adjacent ones of the light-permeable portions in the inner channel

16. The display device according to claim 15, wherein the plurality of light-permeable portions are connected with the communication portion at a junction having an overlapping thickness in a thickness direction, and the overlapping thickness is greater than 15% and less than 35% of a thickness of the plurality of light-permeable portions.

17. The display device according to claim 15, wherein reflective cover further comprises two concave regions located in the center of the reflective cover; one of the concave regions is a closed concave slot and another one is a section of the inner channel that is substantially Z-shaped to connect two of the plurality of segment structures.

18. The display device according to claim 15, wherein inclinations of the ramp section and the step section is substantially between 5 degrees and 10 degrees.

19. The display device according to claim 15, wherein the communication portion is formed by a plurality of step sections, by a plurality of slope sections, or by a combination of the plurality of step sections and the plurality of slope sections being connected to each other.

20. The display device according to claim 14, wherein a distance between the notches of the at least two adjacent ones of the segment structures is 0.5 to 2 times a length of the segment.
